(19) United States
(12) Patent Application Publication
(10) Pub. No.: US 2011/0111608 A1
(43) Pub. Date: May 12, 2011

(54) CONNECTOR

(76) Inventors: Min-I Chen, Taipei County (TW); Yung-Hung Ho, Taipei County (TW); Wei-Chieh Hsu, Taipei County (TW)

(21) Appl. No.: 12/794,784

(22) Filed: Jun. 7, 2010

(30) Foreign Application Priority Data
Nov. 12, 2009 (TW) 098138444

(51) Int. Cl. H01R 12/16

(52) U.S. Cl. 439/78

(57) ABSTRACT

A connector is mounted on a circuit board via its feet of the housing (and/or a frame's feet) mounted at a tilting angle to the circuit board, or via a wedge base of its connector body such that the signal pins and the opening of the housing extend along a direction at the tilting angle relative to the circuit board. An external connector may be plugged into the tilting-type connector at a tilting angle. The feet and signal pins of the connector may be mounted to the circuit board by use of surface mount device (SMD) technology or direct insertion. A plane may be further deployed on the top of the connector for being used by an SMD equipment.

### BACKGROUND OF THE INVENTION

1. Field of the Invention

The invention relates to a connector, and more particularly, to a connector having tilting mounting angle with respect to a PCB.

2. Description of the Prior Art

Digital TV has the trend of getting thinner and incorporating with wall-mount structure so as to blend into housing design. With multiple fields' application and higher supportability in A/V, communications, data processing designed for the TV, receptacle connectors for various external connectors are also enhanced. Such receptacle connectors are primarily configured at the back or the side of a digital TV but getting much harder for plugging/unplugging since the digital TV is getting thinner with much little space left between the TV and the mounting wall.

Please refer to FIG. 1, which is a schematic diagram of a conventional flat panel display 1 showing the situations of its connector 4 when the flat panel display 1 is mounted to the wall 2. The flat panel display 1 is mounted to the wall 2 via a wall-mount frame 3 and usually has a distance D, about 40˜50 mm, from the wall 2. Such short distance D stumbles plugging of the connector 4. FIG. 1 part A shows a common vertical mounting method of the connector 4, which is very difficult for a user to plug the connector 4. FIG. 1 part B shows a horizontal mounting method of the connector 4; however, such way of plugging the connector 4 may be even unachievable thanks to the limited space between the flat panel display 1 and the wall 2.

Besides the aforementioned A/V connectors, such as the D-sub, HDMI, DisplayPort, DVI connectors, used for a flat panel display, connectors applied on other types of devices, such as the network connectors, generic interfaces like USB, Firewire, may also face the same challenge because of the plugging angle.

### SUMMARY OF THE INVENTION

The embodiments of the invention provide a connector for being mounted at a tilting angle to a circuit board. The connector includes a body and a housing. The body is mounted to the circuit board and includes a plurality of signal pins, wherein a first end of each of the signal pins electrically connects to a plurality of electrical nodes of the circuit board and a second end of each of the signal pins extends along a first direction relative to the circuit board. The housing is mounted to the body and includes a pair of first feet mounted to a first mounting part of the circuit board. The second ends of the signal pins of the body are located on at least a plane and are aligned in at least a row along a second direction. The second direction is substantially parallel with the circuit board, and the tilting angle is contained by the first direction and the circuit board.

The embodiments of the invention also provide a flat panel display. The flat panel display includes a circuit board and a connector. The circuit board includes a plurality of electrical nodes and a first mounting part. The connector is mounted at a tilting angle to the circuit board. The connector includes a body and a housing. The body is mounted to the circuit board and includes a plurality of signal pins, wherein a first end of each of the signal pins electrically connects to the plurality of electrical nodes of the circuit board and a second end of each of the signal pins extends along a first direction relative to the circuit board. The housing is mounted to the body and includes a pair of first feet mounted to the first mounting part of the circuit board. The second ends of the signal pins of the body are located on at least a plane and are aligned in at least a row along a second direction. The second direction is substantially parallel with the circuit board, and the tilting angle is contained by the first direction and the circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional flat panel display showing statuses of its connector when mounted to the wall.

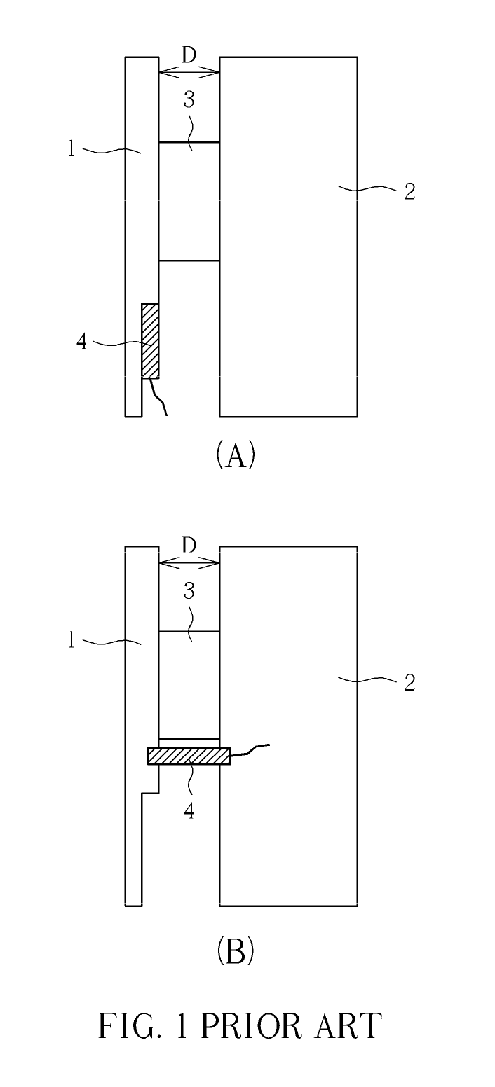

FIG. 2 is a schematic diagram of a flat panel display having a connector of the present invention and mounted to the wall.

FIG. 3 is a schematic diagram of a first embodiment of the connector and a corresponding circuit board.

FIG. 4 is a schematic diagram of the first embodiment shown in another angle.

FIG. 5 is a schematic diagram of a side sectional view of the connector mounted to the circuit board.

FIG. 6 is a schematic diagram of a second embodiment of the connector and a corresponding circuit board.

FIG. 7 is a schematic diagram of a side sectional view of the second embodiment of the connector mounted to the circuit board.

FIG. 8 is a schematic diagram of a third embodiment of the connector mounted to a circuit board.

FIG. 9 is a schematic diagram of the third embodiment mounted to the circuit board shown in another angle.

FIG. 10 is a schematic diagram of a side sectional view of the third embodiment of the connector mounted to the circuit board.

FIG. 11 is a schematic diagram of a fourth embodiment of the connector.

FIG. 12 is a schematic diagram of a side sectional view of the fourth embodiment of the connector mounted to the circuit board.

FIG. 13 is a schematic diagram of a fifth embodiment of the connector.

FIG. 14 is a schematic diagram of a side sectional view of the fifth embodiment of the connector mounted to the circuit board.

### DETAILED DESCRIPTION

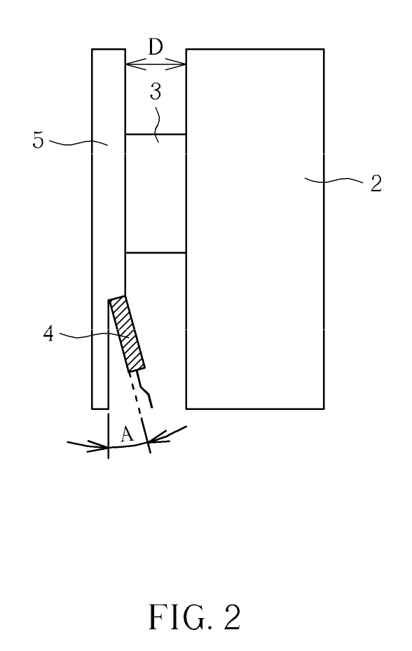

Referring to FIG. 2, a flat panel display 5 according to one embodiment of the present invention is illustrated. A receptacle connector or a connector that is disposed at the back of the flat panel display 5 and allows an external/plug connector 4 to be mounted to the flay panel display 5 at a tilting angle, for example, 15 degree in FIG. 2, thereby making easier for plugging or unplugging the external connector 4. The connector according to the present invention may be of the digital visual interface (DVI) standard or of the D-sub interface standard, mounting to a circuit board, not shown, of the flat panel display 5 at a tilting angle A, preferably within range of 15˜35 degree, relative to the circuit board. The connector may also be of the high-definition multimedia interface (HDMI) standard or of the DisplayPort interface standard, mounting to the circuit board at the tilting angle A, preferably within range of 10˜40 degree. Additionally, the connector may also refer to a network connector, generic interfaces such as the USB, Firewire, and so on. The flat panel display 5 in FIG. 2 with such tilting-type connector provides convenience for plugging/unplugging the rear external connector 4.

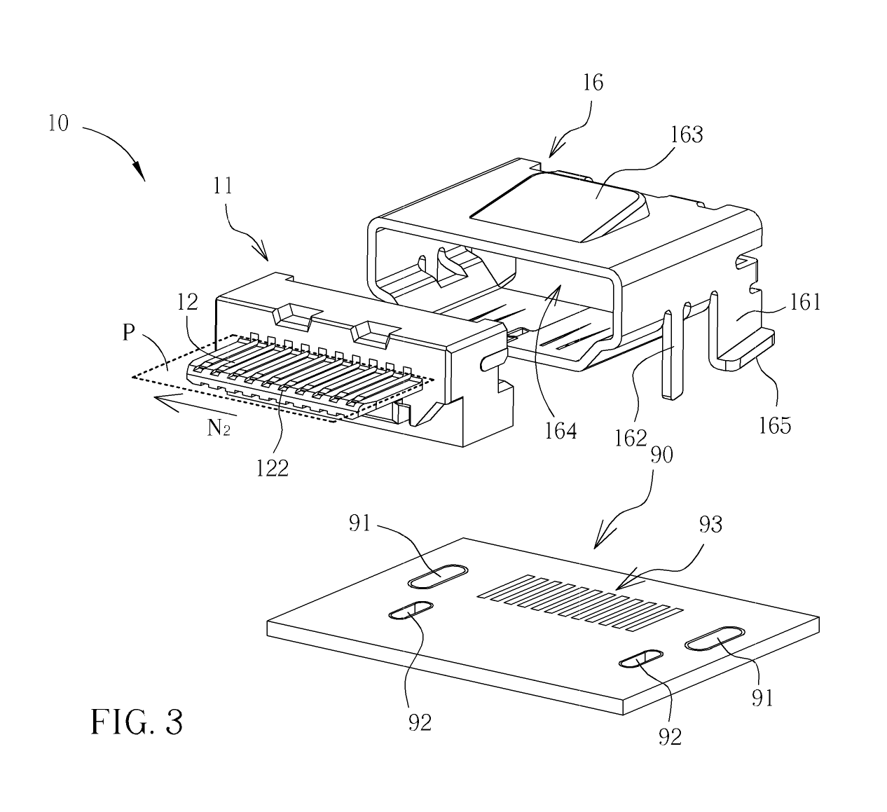

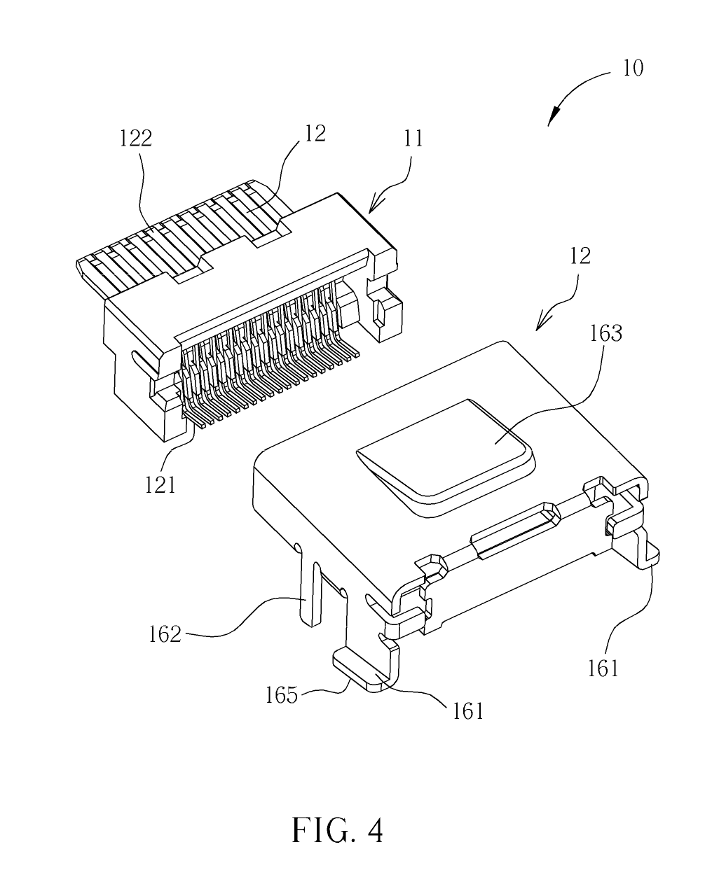

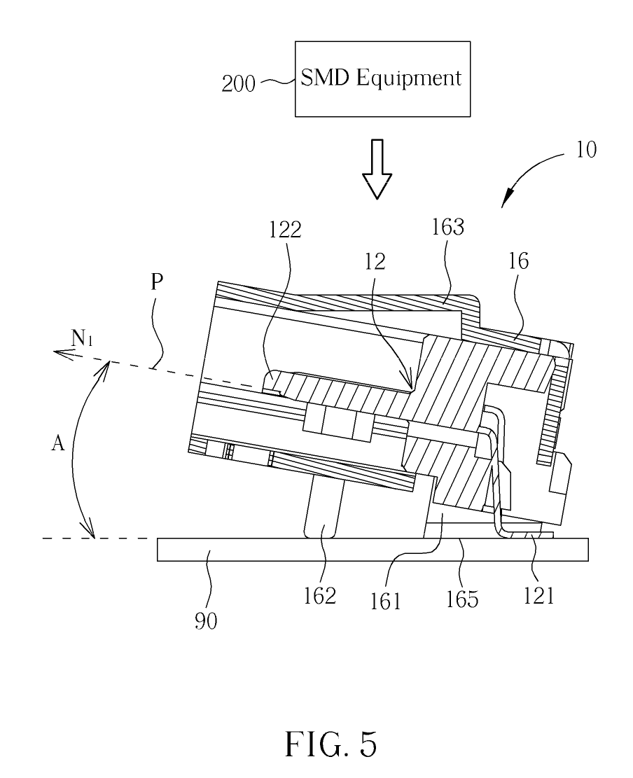

Please refer to FIG. 3 to FIG. 5, which are schematic diagrams showing an exemplary embodiment of a connector 10 according to the present invention. FIG. 3 shows the connector 10 and a corresponding circuit board 90 and FIG. 5 shows a side sectional view of the connector 10 mounted to the circuit board 90. The connector 10 according to the first embodiment of the present invention includes a body 11 and a housing 16. The body 11 includes a plurality of signal pins 12, each having a first end 121 and a second end 122. The first ends 121 of the signal pins 12 electrically connect to electrical nodes 93 of the circuit board 90 while the second ends 122 of the signal pins 12 electrically connect to the electrical nodes of an external connector (not shown in the figure) when the external connector is plugged into the connector 10. In this embodiment, the first ends 121 of the signal pins 12 electrically connect to the electrical nodes 93 by means of surface mount device (SMD) technology. The body 11 and the housing 16 mount to each other to form the connector 10. As the body 11 is mounted to the housing 16, the second ends 122 of the signal pins 12 align with each other in a row along a direction N₂ on a plane P, where the direction N₂ is substantially parallel with the circuit board 90, and each of the second ends 122 extends in the opening 164 of the housing 16 as shown in FIG. 5 such that the external connector may plug into the opening 164 of the housing 16 for being electrically connected to the signal pins 12.

In this embodiment, the connector 10 is mounted and tilted to the circuit board 90 by use of the housing 16. The housing 16 has a pair of first feet 161, each having a first inclined surface for being attached to a first mounting part 91 of the circuit board 90 via SMD such that the housing 16 may be mounted to the circuit board 90 in a tilting way and develop the tilting angle between the body 11 and the circuit board 90. Please referring to FIG. 5, it shows that the first inclined surfaces 165 of the first feet 161 are inclined with respect to the rest of the housing 16. As the first feet 161 is mounted to the first mounting parts 91 of the circuit board 90 through the first inclined surfaces 165, the extension direction N₁ of the housing 16 is also the extension direction N₁ of the second ends 122 and the signal pins 12 of the body 11 located on the plane P and aligned in the opening 164, and the extension direction N₁ and the circuit board 90 contain the tilting angle A. Hence, the plane P and the circuit board 90 also contain the tilting angle A, which is between 10˜40 degree. The housing 16 is made to be mounted to the circuit board 90 at the tilting angle A. Additionally, as the first ends 121 of the signal pins 12 electrically connect to the electrical nodes of the circuit board 90 via SMD, the first ends 121 and the second ends 122 of the signal pins 12 also tilt with each other at the tilting angle A such that the first ends 121 are parallel with the circuit board 90. The relative upward tilting, or outward tilting as shown in FIG. 2, of the opening 164 of the housing 16 and the second ends 122 of the signal pins 12 of the body 11 with respect to the circuit board 90 therefore provides suitable angle for plugging/unplugging an external connector.

Additionally, as the first feet 161 and the first ends 121 are mounted to the circuit board 90 via SMD, a plane surface 163 is further disposed at the top of the housing 16. The plane surface 163 is substantially parallel with the circuit board 90 so that an SMD equipment 200 during SMD process can be attached thereon. The housing 16 further includes a pair of insertion pins 162 for directly inserting into a pair of second mounting parts 92 of the circuit board 90. In other word, the insertion pins 162 are long enough to penetrate the second mounting parts 92, which are through holes of the circuit board 90 so as to allow the insertion pins 162 to be inserted into the through holes and pass through the circuit board 90. The passing portions of the insertion pins 162 at the other side of the through hole may be welded to the circuit board 90 so as to fix the insertion pins 162 to the second mounting parts 92. Such implementation can be used to precisely position the connector 10 on the circuit board 90 when the connector 10 is mounted to the circuit board 90 and enhances strength of mounting.

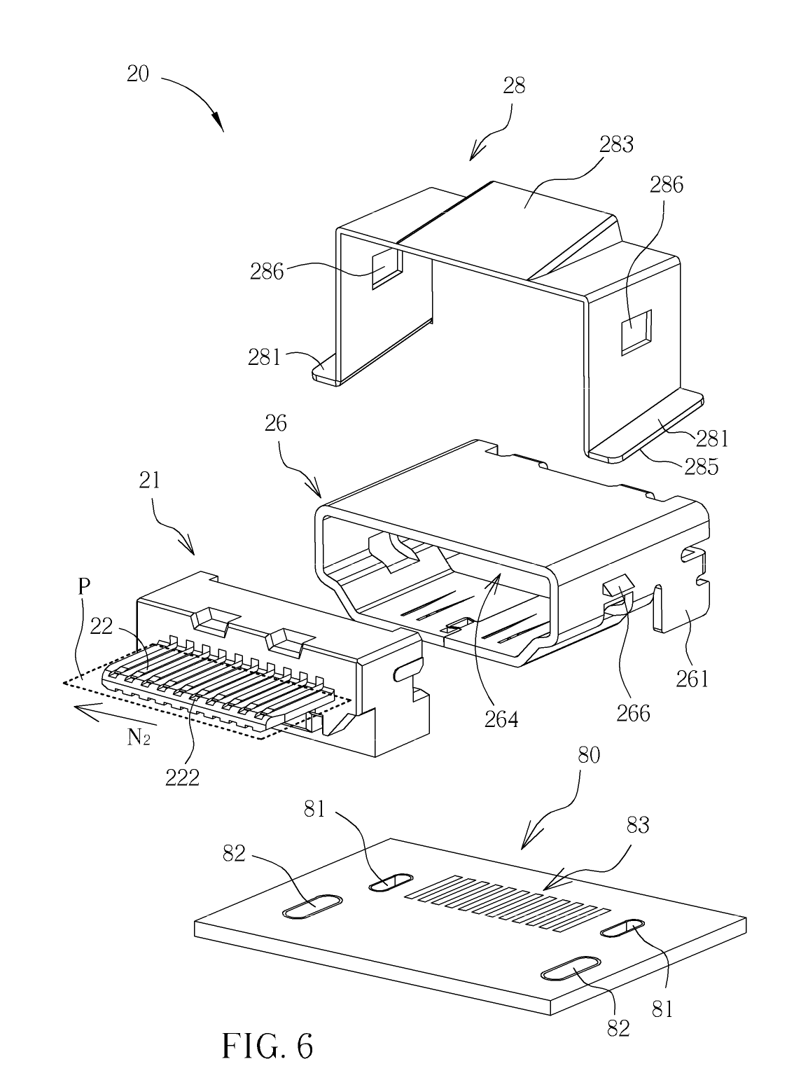

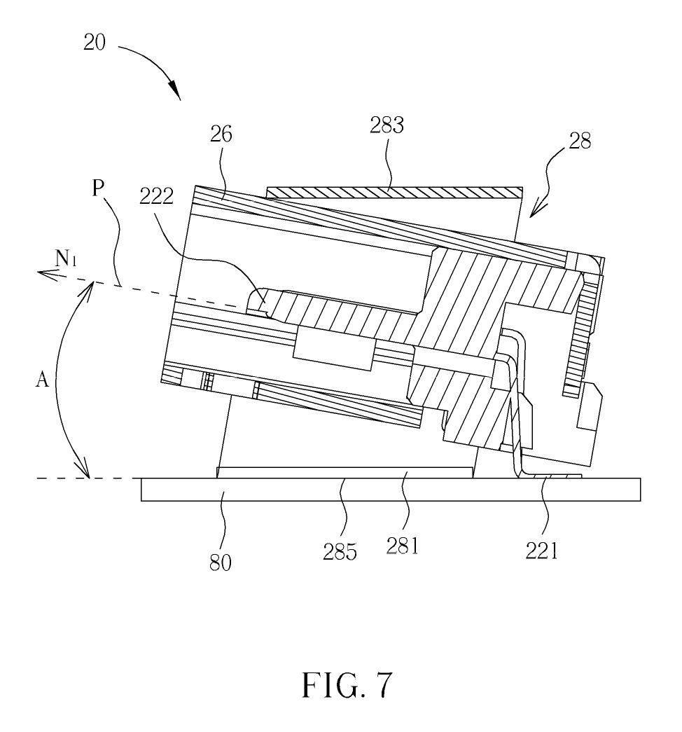

Please refer to FIG. 6 to FIG. 7, which are schematic diagrams showing a second exemplary embodiment of a connector 20 according to the present invention. FIG. 6 shows the connector 20 and a corresponding circuit board 80 and FIG. 7 shows a side sectional view of the connector 20 mounting to the circuit board 80. The body 21 of the connector 20 includes a plurality of signal pins 22, each having a first end 221 and a second end 222. The electrically connection way between the first end 221 of each signal pin 22 and electrical nodes 83 of the circuit board 80 and the tilting angle between the first ends 221 and the second ends 222 are similar to those described in the first embodiment. In the second embodiment, the housing 26 mounts to the circuit board 80 by using a pair of first feet 261 that are directly inserted into a pair of first mounting parts 81 of the circuit board 80. The connector 20 further includes a frame 28. The frame 28 includes frame couplers 286 at both sides, each being coupled with housing couplers 266 at the both sides of the housing 26 such that the frame 28 may be assembled to the housing 26. The body 21 is mounted to the housing 26 with the second ends 222 of the signal pins 22 extending in the opening 264 of the housing 26 as shown in FIG. 7.

In addition to the first feet 261 of the signal pins 22, the connector 20 further includes a pair of second feet 281 at both sides of the frame 28 for being mounted to second mounting parts 82 of the circuit board 80 at the tilting angle A. The connector 20 develops the tilting angle A with the circuit board 80 mainly by use of the frame 28. As shown in the figures, each of the second feet 281 includes a second inclined surface 285 for being attached to the corresponding second mounting part 82 of the circuit board 80 via SMD. Alternatively, in other embodiments of the present invention, the second feet 281 may also be mounted to the second mounting parts 82 via direct insertion. The frame 28, therefore, is mounted to the circuit board 80 in a tilting way. As the second feet 281 are attached to the circuit board 80 by use of the second inclined surface 285, the extension direction N₁ of the housing 26, which is assembled to the frame 28, is also the extension direction N₁ of the second ends 222 and the signal pins 22 of the body 21 extending in the opening 264, and the extension direction N₁ and the circuit board 80 contain the tilting angle A. Hence, the housing 26 and the body 21 with the circuit board 80 may contain the tilting angle A when mounted thereon.

Additionally, a plane surface 283 is further disposed at the top of the frame 28. The plane surface 283 is substantially parallel with the circuit board 80 and has similar function with the plane surface 163. In the second embodiment, the connector 20 is mounted to the circuit board 80 with the first ends 221 of the signal pins 22, the first feet 261 of the housing 26, and the second feet 281 of the frame 28, and is tilting with the circuit board 80 by use of the second feet 281 of the frame 28.

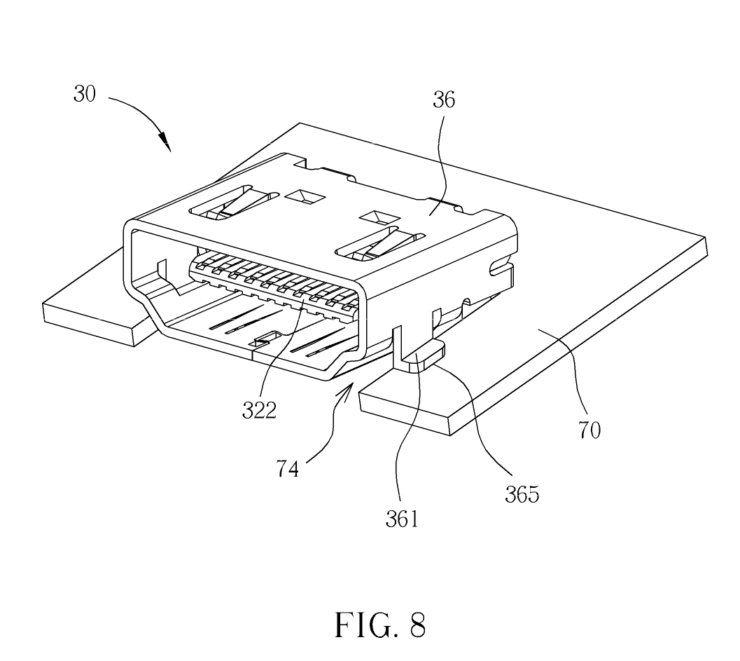

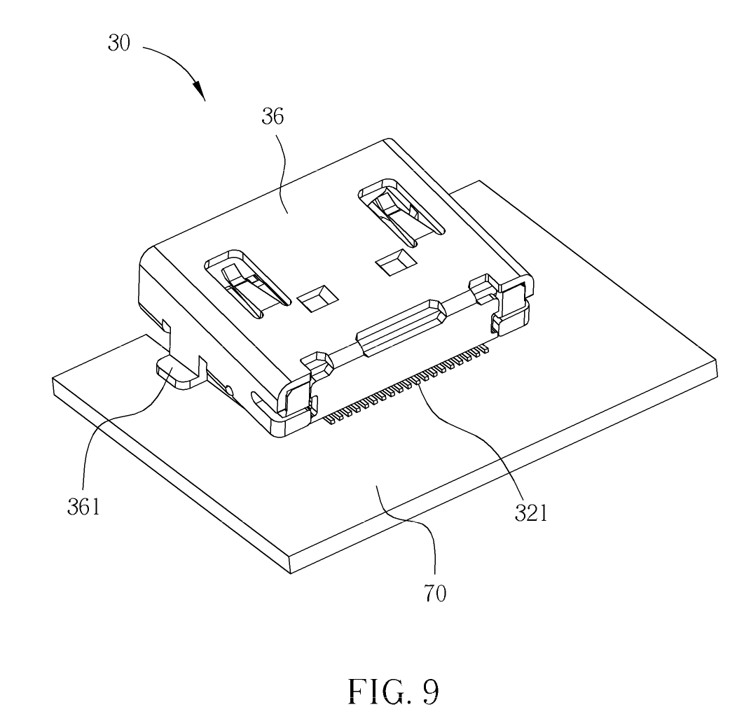

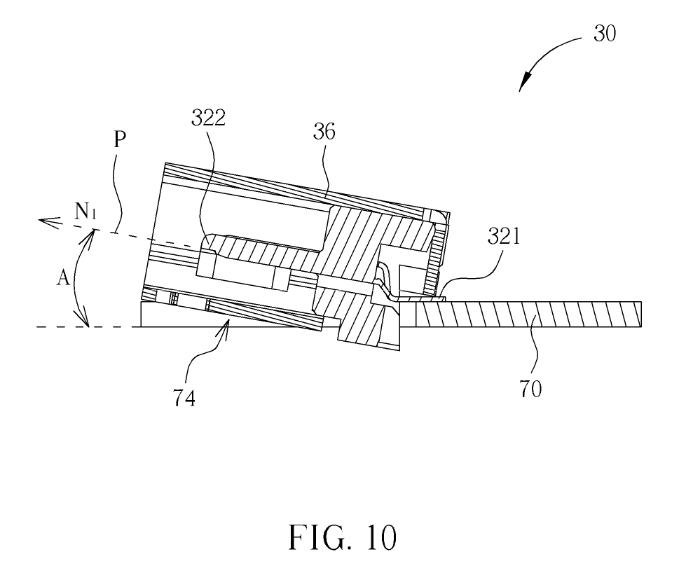

Please refer to FIG. 8 to FIG. 10, which are schematic diagrams showing a third exemplary embodiment of a connector 30 according to the present invention. FIG. 8 and FIG. 9 show the connector 30 mounted to a circuit board 70 shown in different angles and FIG. 10 shows a side sectional view of the connector 30 mounting to the circuit board 70. In the third embodiment, the connector 30 sinks in the circuit board 70 for decreasing the overall thickness. The circuit board 70 includes a breakup structure 74 and the connector 74 mounts to the circuit board 70 by using a pair of first feet 361 at both sides of the housing 36, where the first feet 361 have first inclined surfaces 365 for being attached to the circuit board 70 via SMD. The first ends 321 of the signal pins also electrically connect to the electrical nodes of the circuit board 70 via SMD. It is shown in FIG. 10 that part of the connector 30 sinks in the breakup structure 74 of the circuit board 70 when mounted therein and the dimension of the connector 30 mounted in a tilting way to the circuit board 70 can be further reduced.

As illustrated in FIG. 8 and FIG. 10, the first inclined surfaces 365 have the titling angle with the rest of the housing 36 such that the housing 36 together with the signal pins within may be mounted to the circuit board 70 in a tilting way. The extension direction N₁ of the housing 36 is also the same extension direction N₁ of the second ends 322, and the extension direction N₁ and the circuit board 70 contain the tilting angle A. In the third embodiment, the connector 30 is mounted to the circuit board 70 with the first ends 321 of the signal pins, the first feet 361 of the housing 36, and is tilting with the circuit board 70 by use of the first feet 361 of the housing 36.

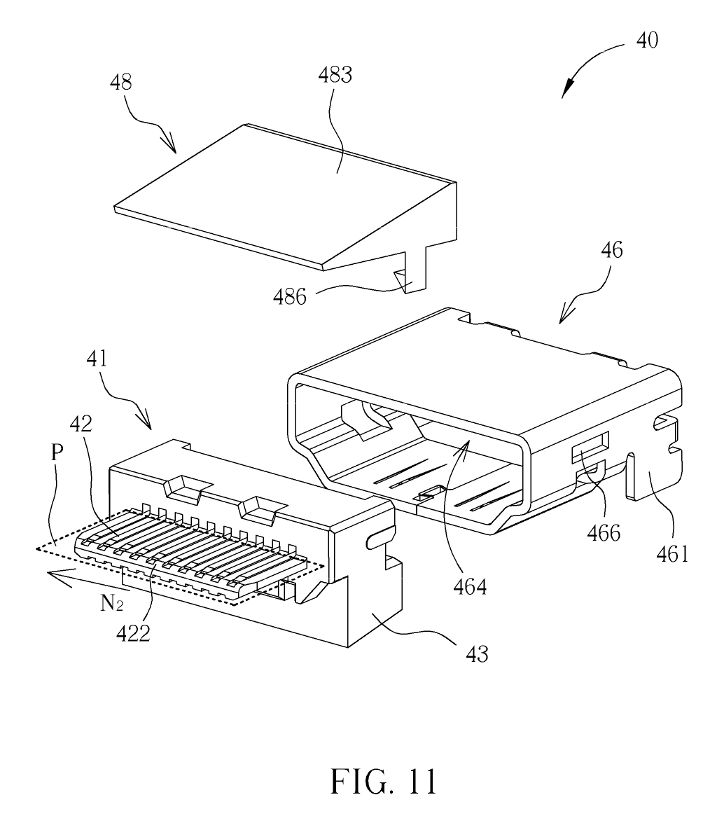

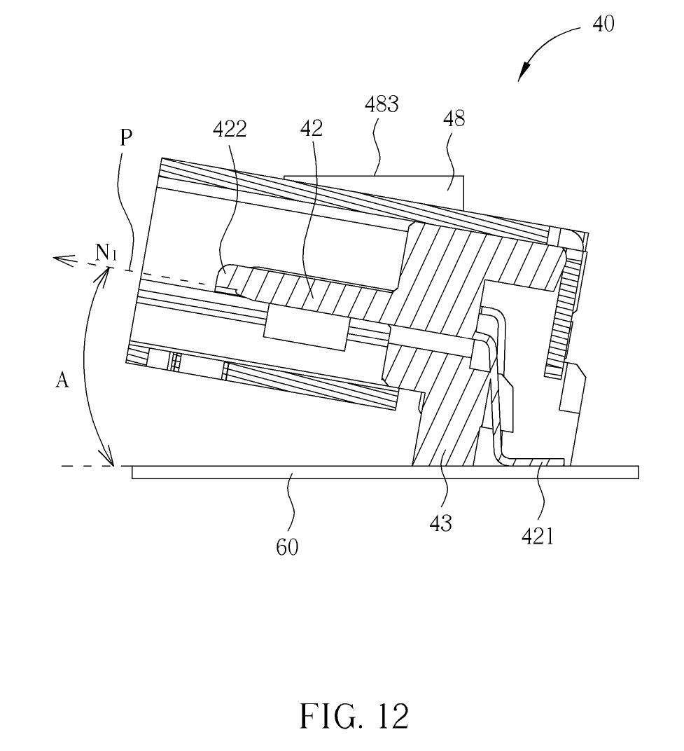

Please refer to FIG. 11 to FIG. 12, which are schematic diagrams showing a fourth exemplary embodiment of a connector 40 according to the present invention. FIG. 11 shows each component of the connector 40 and FIG. 12 shows a side sectional view of the connector 40 mounted to a circuit board 60. The fourth embodiment of the connector 40 includes a body 41, a housing 46, and a frame 48. The body 41 includes a plurality of signal pins 42, each having a first end 421 and a second end 422. In this embodiment, the first ends 421 of the signal pins 42 electrically connect to the electrical nodes of the circuit board 60 via SMD. The second ends 422 of the signal pins 42 align with each other in a row along a direction N₂ on a plane P, where the direction N₂ is substantially parallel with the circuit board 60. The body 41 and the housing 46 mount to each other to form the connector 40. As the body 41 is mounted to the housing 46, each of the second ends 422 extends in the opening 464 of the housing 46 such that the external connector may plug into the opening 464 of the housing 46 for being electrically connected to the signal pins 42.

In the fourth embodiment, the connector 40 is tilting with the circuit board 60 by use of the body 41. The body 41 includes a wedge base 43 that has a shape to make the second ends 422 of the signal pins 42 to extend toward the direction N₁, which contains the tilting angle A with the circuit board 60, when the body 41 is mounted to the circuit board 60. Since the housing 46 assembles to the body 41, the opening 464 of the housing 46 also extends toward direction N₁, having the titling angle A with the circuit board 60. Additionally, the housing 46 includes a pair of first feet 461 that may further insert into corresponding mounting parts of the circuit board 60 via direct insertion and provide positioning base when the connector 40 is mounted to the circuit board 60 and enhances strength of mounting.

The frame 48 of the connector 40 is assembled to the housing 46 by using a pair of frame couplers 486 at both sides coupling with housing couplers 466 of the housing 46. The frame 48 has a plane surface 483 at the top of the frame 48. The plane surface 483 is substantially parallel with the circuit board 60 when the frame 48 is assembled to the housing 46, and the housing 46 together with the body 41 are mounted to the circuit board 60 in a tilting way. The plane surface 483 has similar function with the plane surface 163 and the detailed description is omitted for brevity. In the fourth embodiment, the connector 40 is mounted to the circuit board 60 with the first ends 421 of the signal pins 42, the first feet 461 of the housing 46, and is tilting with the circuit board 60 by use of the wedge base 43 of the body 41.

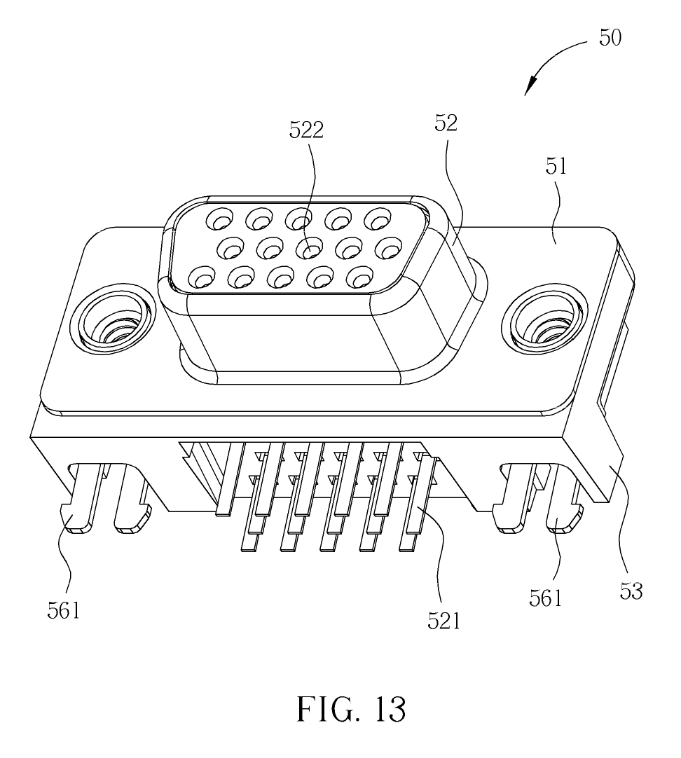

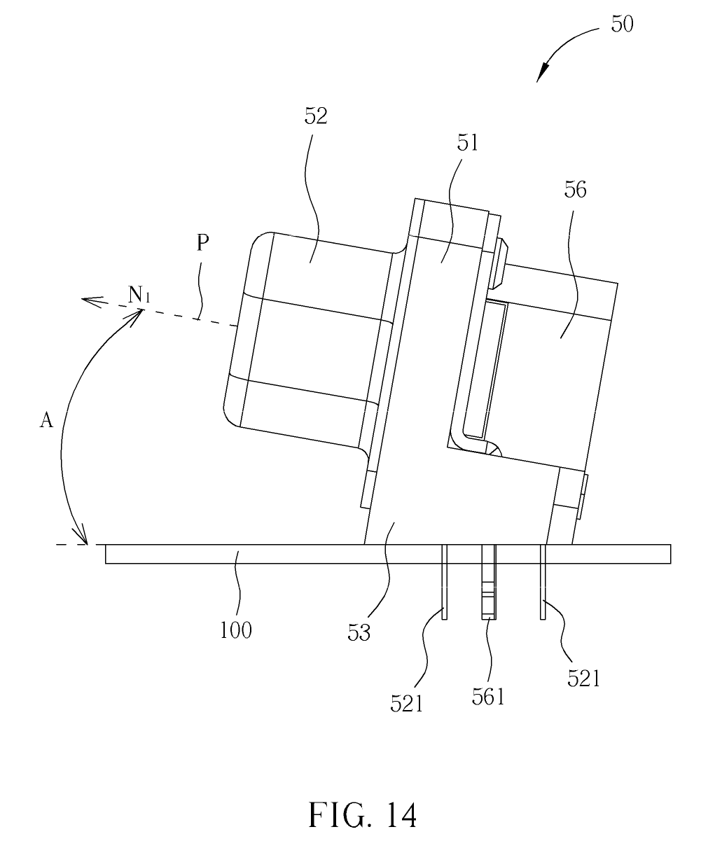

Please refer to FIG. 13 to FIG. 14, which are schematic diagrams showing a fifth exemplary embodiment of a connector 50 according to the present invention. FIG. 14 shows a side sectional view of the connector 50 mounted to a circuit board 100. The fifth embodiment of the connector 50 includes a body 51 and a housing 56. A signal plug 52 of the body 51 includes a plurality of first ends 521 and a plurality of second ends 522, each of the first ends 521 electrically connecting to the electrical nodes of the circuit board 100 via direct insertion, and each of the second ends 522 aligning with each other in multiple rows along a direction on multiple planes that are parallel with a plane P. The body 51 and the housing 56 mount to each other to form the connector 50, while the connector 50 is tilting with the circuit board 100 by use of the body 51. The body 51 includes a wedge base 53 that has a shape to make the signal plug 52 to extend toward the direction N₁, which contains the tilting angle A with the circuit board 100, when the body 51 is mounted to the circuit board 100. The connector 50 is therefore having the tilting angle A with the circuit board 100 when mounted thereon. Additionally, the housing 56 includes a pair of first feet 561, which are resilient clips in this embodiment, that may further be inserted into corresponding mounting parts of the circuit board 100 and provide positioning base when the connector 50 is mounted to the circuit board 100 and enhances strength of mounting. In the fifth embodiment, the connector 50 is mounted to the circuit board 100 with the first ends 521 of the signal pins 52, the first feet 561 of the housing 56, and is tilting with the circuit board 100 by use of the wedge base 53 of the body 51.

The flat panel display and the connector disclosed in the present invention have the connector mounted on the circuit board via its feet of the housing (and/or the frame's feet) mounted at a tilting angle to the circuit board, or via the wedge base of the body such that the signal pins and the opening of the housing extend along the direction at the tilting angle relative to the circuit board. The corresponding external connector may be plugged into the tilting-type connector at a tilting angle, adding more flexibility and convenience to use the connector. The feet and signal pins of the connector may be mounted to the circuit board by use of surface mount device (SMD) technology or direct insertion. A plane may be further deployed on the top of the connector for being used by an SMD equipment. The tilting-type connector allows easier plugging/unplugging of the connector, when the flat panel display is hanged on the wall in particular. On the other hand, for connectors applied on other types of devices, such as the network connectors, generic interfaces like USB, Firewire, the tilting structure disclosed in the present invention enhances these connectors with great adaptable convenience.

Those skilled in the art will readily observe that numerous modifications and alterations of the device and method may be made while retaining the teachings of the invention.

What is claimed is:

1. A connector for being mounted at a tilting angle to a circuit board, the connector comprising:
a body mounted to the circuit board and comprising a plurality of signal pins, wherein a first end of each of the signal pins electrically connects to a plurality of electrical nodes of the circuit board and a second end of each of the signal pins extends along a first direction relative to the circuit board; and
a housing mounted to the body and comprising a pair of first feet mounted to a first mounting part of the circuit board;
wherein the second ends of the signal pins of the body are located on at least a plane and are aligned in at least a row along a second direction, wherein the second direction is substantially parallel with the circuit board, and the tilting angle is contained by the first direction and the circuit board.

2. The connector of claim 1, wherein the connector is of the digital visual interface (DVI) standard or of the D-sub interface standard, and the tilting angle is within range of 15˜35 degree.

3. The connector of claim 1, wherein the connector is of the high-definition multimedia interface (HDMI) standard or of the DisplayPort interface standard, and the tilting angle is within range of 10˜40 degree.

4. The connector of claim 1, wherein the pair of first feet are mounted to the first mounting part of the circuit board via surface mount device (SMD) technology or direct insertion.

5. The connector of claim 1, wherein the first ends of the signal pins electrically connect to the plurality of electrical nodes of the circuit board via surface mount device (SMD) technology and tilt relative to the second ends of the signal pins at the tilting angle.

6. The connector of claim 1, wherein the first ends of the signal pins electrically connect to the electrical nodes of the circuit board via direct insertion.

7. The connector of claim 1, wherein each of the first feet of the housing comprises a first inclined surface attached to the circuit board such that the housing is mounted to the circuit board in a tilting way for developing the tilting angle between the body and the circuit board.

8. The connector of claim 1, further comprising a frame assembled to the housing for being mounted to a second mounting part of the circuit board and for developing the tilting angle between the body and the circuit board.

9. The connector of claim 8, wherein the frame comprises a pair of second feet mounted to the second mounting part of the circuit board via surface mount device (SMD) technology or direct insertion.

10. The connector of claim 9, wherein each of the second feet comprises a second inclined surface attached to the circuit board such that the frame is mounted to the circuit board in a tilting way.

11. The connector of claim 8, wherein the frame comprises a frame coupler, and the housing comprises a housing coupler for coupling with the frame coupler such that the frame is assembled to the housing.

12. The connector of claim 8, wherein the frame comprises a plane surface substantially parallel with the circuit board for providing attachment for an SMD equipment.

13. The connector of claim 7, wherein the circuit board comprises a breakup structure where the connector sinks.

14. The connector of claim 1, wherein the body comprises a wedge base for being mounted to the circuit board and for orienting the second ends of the signal pins toward the first direction.

15. The connector of claim 14, further comprising a frame assembled to the housing wherein the frame comprises a plane surface substantially parallel with the circuit board for providing attachment for an SMD equipment.

16. The connector of claim 15, wherein the frame comprises a frame coupler, and the housing comprises a housing coupler for coupling with the frame coupler such that the frame is assembled to the housing.

17. The connector of claim 1, wherein the housing comprises a plane surface substantially parallel with the circuit board for providing attachment for an SMD equipment.

18. A flat panel display, comprising:
a circuit board comprising a plurality of electrical nodes and a first mounting part; and
a connector for being mounted at a tilting angle to the circuit board, the connector comprising:
a body mounted to the circuit board and comprising a plurality of signal pins, wherein a first end of each of the signal pins electrically connects to the plurality of electrical nodes of the circuit board and a second end of each of the signal pins extends along a first direction relative to the circuit board; and
a housing mounted to the body and comprising a pair of first feet mounted to the first mounting part of the circuit board;
wherein the second ends of the signal pins of the body are located on at least a plane and are aligned in at least a row along a second direction, wherein the second direction is substantially parallel with the circuit board, and the tilting angle is contained by the first direction and the circuit board.

19. The flat panel display of claim 18, wherein the connector is of the digital visual interface (DVI) standard or of the D-sub interface standard, and the tilting angle is within range of 15˜35 degree.

20. The flat panel display of claim 18, wherein the connector is of the high-definition multimedia interface (HDMI) standard or of the DisplayPort interface standard, and the tilting angle is within range of 10˜40 degree.

21. The flat panel display of claim 18, wherein the pair of first feet are mounted to the first mounting part of the circuit board via surface mount device (SMD) technology or direct insertion.

22. The flat panel display of claim 18, wherein the first ends of the signal pins electrically connect to the plurality of electrical nodes of the circuit board via surface mount device (SMD) technology or direct insertion.

23. The flat panel display of claim 18, wherein each of the first feet of the housing comprises a first inclined surface attached to the circuit board such that the housing is mounted to the circuit board in a tilting way for developing the tilting angle between the body and the circuit board.

24. The flat panel display of claim 18, further comprising a frame assembled to the housing, the frame comprising a pair of second feet mounted to a second mounting part of the circuit board via surface mount device (SMD) technology or direct insertion for developing the tilting angle between the body and the circuit board.

25. The flat panel display of claim 24, wherein each of the second feet comprises a second inclined surface attached to the circuit board such that the frame is mounted to the circuit board in a tilting way.

26. The flat panel display of claim 24, wherein the frame comprises a frame coupler, and the housing comprises a housing coupler for coupling with the frame coupler such that the frame is assembled to the housing.

27. The flat panel display of claim 24, wherein the frame comprises a plane surface substantially parallel with the circuit board for providing attachment for an SMD equipment.

28. The flat panel display of claim 23, wherein the circuit board comprises a breakup structure where the connector sinks.

29. The flat panel display of claim 18, wherein the body comprises a wedge base for being mounted to the circuit board and for orienting the second ends of the signal pins toward the first direction.

30. The flat panel display of claim 29, wherein the connector further comprises a frame comprising a frame coupler, the housing comprises a housing coupler for coupling with the frame coupler such that the frame is assembled to the housing, and the frame comprises a plane surface substantially parallel with the circuit board for providing attachment for an SMD equipment.

31. The flat panel display of claim 18, wherein the housing comprises a plane surface substantially parallel with the circuit board for providing attachment for an SMD equipment.
